(19) United States
(12) Patent Application Publication
(10) Pub. No.: US 2025/0125439 A1
(43) Pub. Date: Apr. 17, 2025

(54) VEHICLE AND HEAT EXCHANGE PLATE

(71) Applicant: PANASONIC AUTOMOTIVE SYSTEMS CO., LTD., Kanagawa (JP)

(72) Inventors: Atsushi SUEYOSHI, Tokyo (JP); Katsuji TANIGUCHI, Kanagawa (JP); Yuki MAKITA, Kanagawa (JP); Atsushi TOMITA, Tokyo (JP)

(73) Assignee: PANASONIC AUTOMOTIVE SYSTEMS CO., LTD., Kanagawa (JP)

(21) Appl. No.: 19/002,036

(22) Filed: Dec. 26, 2024

Related U.S. Application Data
(63) Continuation of application No. PCT/JP2023/006917, filed on Feb. 27, 2023.

(30) Foreign Application Priority Data
Jun. 30, 2022 (JP) 2022-106394
Jun. 30, 2022 (JP) 2022-106395

(51) Int. Cl. H01M 10/6556; B60K 1/04; H01M 10/613; H01M 10/617; H01M 10/625; H01M 10/6568; H01M 10/6569

(52) U.S. Cl. CPC H01M 10/6556; B60K 1/04; H01M 10/613; H01M 10/617; H01M 10/625; H01M 10/6568; H01M 10/6569; B60K 2001/0438

(57) ABSTRACT

In a heat exchange plate, a refrigerant layer includes first and second refrigerant flow paths and a third refrigerant flow path disposed between the first and second refrigerant flow paths. A coolant layer includes first and second coolant flow paths, and first and second connection coolant flow paths. The first connection coolant flow path connects a part of the first coolant flow path closer to the second refrigerant flow path than the third refrigerant flow path and a part of the second coolant flow path closer to the third refrigerant flow path than the first refrigerant flow path. The second connection coolant flow path connects a part of the first coolant flow path closer to the third refrigerant flow path than the second refrigerant flow path and a part of the second coolant flow path closer to the first refrigerant flow path than the third refrigerant flow path.

### TECHNICAL FIELD

The present disclosure relates to a vehicle and a heat exchange plate.

### BACKGROUND ART

Patent Literature 1 discloses the following configuration. A power supply device for a vehicle includes a battery block formed by connecting a plurality of battery cells, a cooling plate that is thermally coupled to the battery cells of the battery block and cools the battery cells with a supplied refrigerant, a cooling mechanism that supplies the refrigerant to the cooling plate, and a control circuit that controls the cooling mechanism to control a cooling state of the cooling plate. The cooling plate is provided with a watertight hollow portion therein, which is filled with a coolant that uniforms a temperature of the cooling plate. Further, the cooling plate further includes a heat exchanger that cools the coolant by heat of vaporization of the refrigerant. In the power supply device, the heat exchanger is cooled by the heat of vaporization of the refrigerant circulated in the heat exchanger of the cooling plate, the heat exchanger cools the coolant, and the cooling plate cools the battery cells.

### CITATION LIST

### Patent Literature

Patent Literature 1: JP2010-50000A
Patent Literature 2: JP2008-44476A
Patent Literature 3: JP6098121B

### SUMMARY OF INVENTION

When a temperature of a plate that cools a vehicle battery is non-uniform, the battery is cooled non-uniformly. The non-uniform cooling of the battery adversely affect the performance and life of the battery.

An object of the present disclosure is to provide a technique that can more uniformly cool a vehicle battery.

According to an aspect of the present disclosure, there is provided a vehicle including:
a vehicle body;
a first wheel and a second wheel coupled to the vehicle body;
a secondary battery disposed along a predetermined plane in the vehicle body;
a heat exchange plate disposed along the predetermined plane in the vehicle body; and
an electric motor configured to drive at least the first wheel using electric power supplied from the secondary battery, in which
the vehicle is movable in a predetermined direction by the first wheel and the second wheel,
the heat exchange plate includes
   a first surface disposed along the predetermined plane and configured to perform heat exchange with the secondary battery,
   a second surface disposed along the predetermined plane and opposite to the first surface,
   a first end portion in the predetermined direction,
   a second end portion opposite to the first end portion in the predetermined direction,
   a refrigerant input portion disposed at the first end portion and configured to allow a refrigerant to enter the heat exchange plate,
   a refrigerant output portion disposed at the first end portion and configured to allow the refrigerant to exit the heat exchange plate,
   a first refrigerant flow path connected to the refrigerant output portion and disposed along the predetermined direction between the first surface and the second surface,
   a second refrigerant flow path connected to the refrigerant output portion and disposed along the predetermined direction between the first surface and the second surface,
   a third refrigerant flow path connected to the refrigerant input portion and disposed along the predetermined direction between the first surface and the second surface and between the first refrigerant flow path and the second refrigerant flow path,
   a first connection refrigerant flow path connecting the third refrigerant flow path and the first refrigerant flow path between the first surface and the second surface, and
   a second connection refrigerant flow path connecting the third refrigerant flow path and the second refrigerant flow path between the first surface and the second surface,
the refrigerant that has entered the heat exchange plate from the refrigerant input portion is movable from the third refrigerant flow path through the first connection refrigerant flow path and the first refrigerant flow path to the refrigerant output portion, and the refrigerant that has entered the heat exchange plate from the refrigerant input portion is movable from the third refrigerant flow path through the second connection refrigerant flow path and the second refrigerant flow path to the refrigerant output portion,
the heat exchange plate further includes
   a first coolant input and output portion disposed at the first end portion and configured to allow a coolant to be input to and output from the heat exchange plate,
   a second coolant input and output portion disposed at the first end portion and configured to allow the coolant to be input to and output from the heat exchange plate,
   a first coolant flow path connected to the first coolant input and output portion and disposed along the predetermined direction between the first surface and the second surface,
   a second coolant flow path connected to the second coolant input and output portion and disposed along the predetermined direction between the first surface and the second surface,
   a first connection coolant flow path connecting a part of the first coolant flow path closer to the second refrigerant flow path than the third refrigerant flow path and a part of the second coolant flow path closer to the third refrigerant flow path than the first refrigerant flow path at the second end portion, and
   a second connection coolant flow path connecting a part of the first coolant flow path closer to the third refrigerant flow path than the second refrigerant flow path and a part of the second coolant flow path closer to the first refrigerant flow path than the third refrigerant flow path at the second end portion, and
the coolant that has entered the heat exchange plate from the first coolant input and output portion is movable from the first coolant flow path through the first connection coolant flow path and the second coolant flow path to the second coolant input and output portion, and the coolant that has entered the heat exchange plate from the first coolant input and output portion is movable from the first coolant flow path through the second connection coolant flow path and the second coolant flow path to the second coolant input and output portion.

According to an aspect of the present disclosure, there is provided a heat exchange plate mountable on a vehicle movable in a predetermined direction by a first wheel and a second wheel,
the vehicle including
a vehicle body,
the first wheel and the second wheel coupled to the vehicle body,
a secondary battery disposed along a predetermined plane in the vehicle body, and
an electric motor configured to drive at least the first wheel using electric power supplied from the secondary battery,
the heat exchange plate including:
a first surface disposed along the predetermined plane and configured to perform heat exchange with the secondary battery;
a second surface disposed along the predetermined plane and opposite to the first surface;
a first end portion in the predetermined direction;
a second end portion opposite to the first end portion in the predetermined direction;
a refrigerant input portion disposed at the first end portion and configured to allow a refrigerant to enter the heat exchange plate;
a refrigerant output portion disposed at the first end portion and configured to allow the refrigerant to exit the heat exchange plate;
a first refrigerant flow path connected to the refrigerant output portion and disposed along the predetermined direction between the first surface and the second surface;
a second refrigerant flow path connected to the refrigerant output portion and disposed along the predetermined direction between the first surface and the second surface;
a third refrigerant flow path connected to the refrigerant input portion and disposed along the predetermined direction between the first surface and the second surface and between the first refrigerant flow path and the second refrigerant flow path;
a first connection refrigerant flow path connecting the third refrigerant flow path and the first refrigerant flow path between the first surface and the second surface; and
a second connection refrigerant flow path connecting the third refrigerant flow path and the second refrigerant flow path between the first surface and the second surface, in which
the refrigerant that has entered the heat exchange plate from the refrigerant input portion is movable from the third refrigerant flow path through the first connection refrigerant flow path and the first refrigerant flow path to the refrigerant output portion, and the refrigerant that has entered the heat exchange plate from the refrigerant input portion is movable from the third refrigerant flow path through the second connection refrigerant flow path and the second refrigerant flow path to the refrigerant output portion,
the heat exchange plate further includes:
   a first coolant input and output portion disposed at the first end portion and configured to allow a coolant to be input to and output from the heat exchange plate;
   a second coolant input and output portion disposed at the first end portion and configured to allow the coolant to be input to and output from the heat exchange plate;
   a first coolant flow path connected to the first coolant input and output portion and disposed along the predetermined direction between the first surface and the second surface;
   a second coolant flow path connected to the second coolant input and output portion and disposed along the predetermined direction between the first surface and the second surface;
   a first connection coolant flow path connecting a part of the first coolant flow path closer to the second refrigerant flow path than the third refrigerant flow path and a part of the second coolant flow path closer to the third refrigerant flow path than the first refrigerant flow path at the second end portion; and
   a second connection coolant flow path connecting a part of the first coolant flow path closer to the third refrigerant flow path than the second refrigerant flow path and a part of the second coolant flow path closer to the first refrigerant flow path than the third refrigerant flow path at the second end portion, and
the coolant that has entered the heat exchange plate from the first coolant input and output portion is movable from the first coolant flow path through the first connection coolant flow path and the second coolant flow path to the second coolant input and output portion, and the coolant that has entered the heat exchange plate from the first coolant input and output portion is movable from the first coolant flow path through the second connection coolant flow path and the second coolant flow path to the second coolant input and output portion.

According to the present disclosure, a vehicle battery can be cooled more uniformly.

### BRIEF DESCRIPTION OF DRAWINGS

FIG. 1 is a plan view showing a configuration example of a vehicle according to a first embodiment;

FIG. 2 is a left side view showing the configuration example of the vehicle according to the first embodiment;

FIG. 3 is a diagram showing an example of an electric circuit provided in the vehicle according to the first embodiment;

FIG. 4 is a perspective view showing a configuration example of a battery pack according to the first embodiment;

FIG. 5 is a cross-sectional view taken along a line A-A of the battery pack shown in FIG. 4;

FIG. 6 is a plan view showing a configuration example of a refrigerant layer according to the first embodiment;

FIG. 7 is a plan view showing a configuration example of a coolant layer according to the first embodiment;

FIG. 8 is a plan view showing an example of a positional relationship between the refrigerant layer and the coolant layer according to the first embodiment;

FIG. 9 is a perspective view showing a configuration example in which a first connection coolant flow path and a second connection coolant flow path cross three-dimensionally according to the first embodiment;

FIG. 10 is a plan view showing the configuration example in which the first connection coolant flow path and the second connection coolant flow path cross three-dimensionally according to the first embodiment;

FIG. 11 is a plan view showing a configuration example of a heat exchange plate according to a second embodiment;

FIG. 12 is a diagram showing a case in which a circulation direction of a coolant is switched in the heat exchange plate according to the second embodiment; and

FIG. 13 is a plan view showing a configuration example of a heat exchange plate according to a third embodiment.

### DESCRIPTION OF EMBODIMENTS

Hereinafter, embodiments of the present disclosure will be described in detail with reference to the drawings as appropriate. However, more detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

### First Embodiment

### Configuration of Vehicle

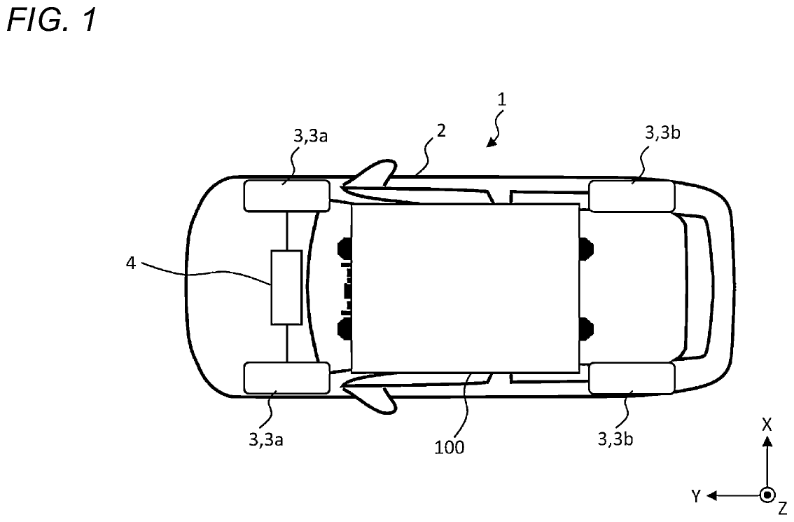

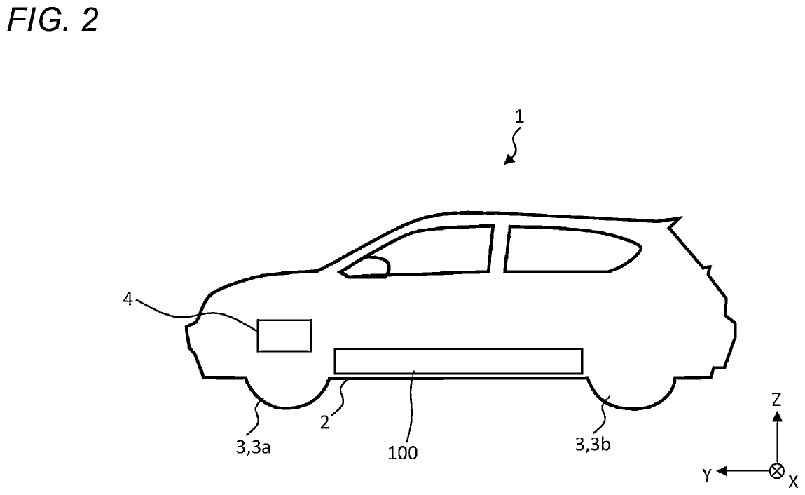

FIG. 1 is a plan view showing a configuration example of a vehicle 1 according to a first embodiment. FIG. 2 is a left side view showing the configuration example of the vehicle 1 according to the first embodiment.

For convenience of description, as shown in FIGS. 1 and 2, an axis extending in a height direction of the vehicle 1 is taken as a Z axis. An axis perpendicular to the Z axis (that is, parallel to ground) and extending in a traveling direction of the vehicle 1 is taken as a Y axis. An axis perpendicular to the Y axis and the Z axis (that is, an axis in a width direction of the vehicle 1) is taken as an X axis. For convenience of description, a positive direction of the Z axis may be referred to as “upper”, a negative direction of the Z axis may be referred to as “lower”, a positive direction of the Y axis may be referred to as “front”, a negative direction of the Y axis may be referred to as “rear”, a positive direction of the X axis may be referred to as “right”, and a negative direction of the X axis may be referred to as “left”. These expressions are the same for other drawings describing the XYZ axes. The expressions related to these directions are used for convenience of explanation, and are not intended to limit a posture of the structure in actual use.

As shown in FIG. 1 or FIG. 2, the vehicle 1 includes a vehicle body 2, wheels 3, an electric motor 4, and a battery pack 10.

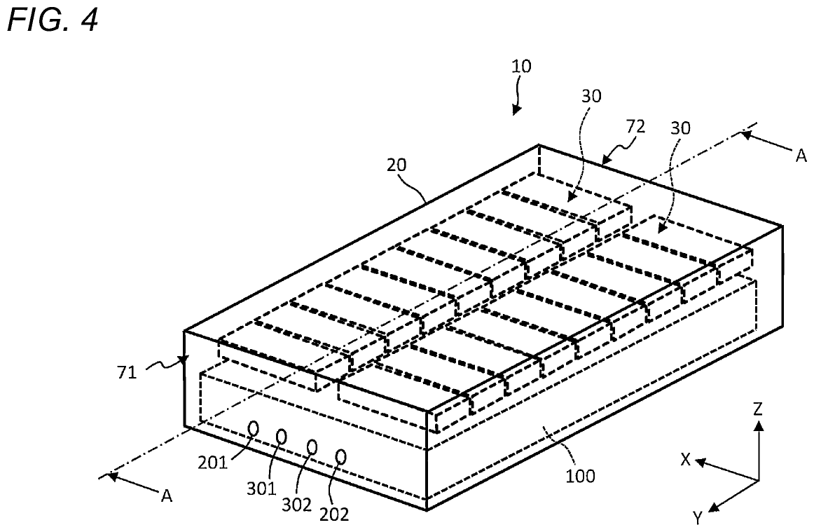

The battery pack 10 is accommodated in the vehicle body 2. The battery pack 10 includes one or more secondary batteries 30 (see FIG. 4) capable of being charged and discharged. An example of the secondary battery 30 is a lithium ion battery. The secondary battery 30 to be described below may be one or more. The secondary battery 30 supplies (discharges) stored electric power to the electric motor 4 or the like. The secondary battery 30 may store (charge) electric power generated by the electric motor 4 by regenerative energy. As shown in FIG. 1, the battery pack 10 may be accommodated under a floor of a center of the vehicle body 2. The battery pack 10 will be described in detail later.

The wheels 3 are coupled to the vehicle body 2. Although FIGS. 1 and 2 show an automobile in which the vehicle 1 includes four wheels 3, the vehicle 1 may include at least one wheel 3. For example, the vehicle 1 may be a motorcycle including two wheels 3 or a vehicle including three or five or more wheels 3. Further, one of the plurality of wheels 3 provided in the vehicle 1 may be referred to as a first wheel 3a, and one of the plurality of wheels 3, which is different from the first wheel 3a, may be referred to as a second wheel 3b. The first wheel 3a may be a front wheel of the vehicle 1, and the second wheel 3b may be a rear wheel of the vehicle 1. The vehicle 1 is movable in a predetermined direction (for example, a front-rear direction) by the first wheel 3a and the second wheel 3b.

The electric motor 4 drives at least one wheel 3 (for example, the first wheel 3a) using the electric power supplied from the secondary battery 30. The vehicle 1 includes at least one electric motor 4. The vehicle 1 may have a configuration in which the electric motor 4 drives the front wheel (that is, a front wheel drive configuration). Alternatively, the vehicle 1 may have a configuration in which the electric motor 4 drives the rear wheel (that is, a rear wheel drive configuration) or a configuration in which the electric motor 4 drives both the front wheel and the rear wheel (that is, a four wheel drive configuration). Alternatively, the vehicle 1 may include a plurality of electric motors 4, and each of the plurality of electric motors 4 may individually drive the wheel 3. The electric motor 4 may be installed in a motor room (engine room) located in front of the vehicle 1.

### Configuration of Electric Circuit

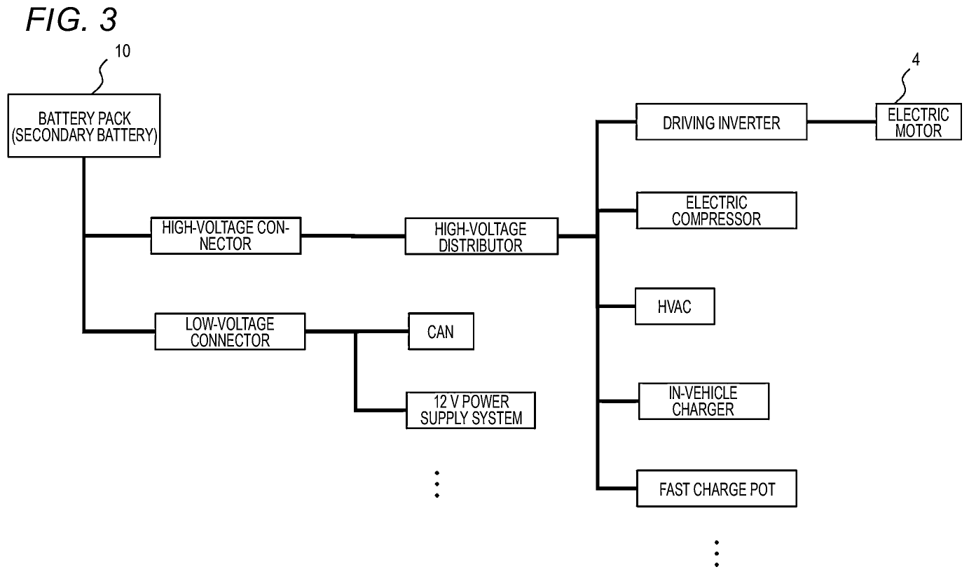

FIG. 3 is a diagram showing an example of an electric circuit provided in the vehicle 1 according to the first embodiment.

The battery pack 10 including the secondary battery 30 includes a high-voltage connector and a low-voltage connector. In the present disclosure, the high-voltage connector and the low-voltage connector are referred to as electrical connectors without being distinguished from each other.

A high-voltage distributor may be connected to the high-voltage connector. A driving inverter, an electric compressor, a heating, ventilation, and air conditioning (HVAC), an in-vehicle charger, and a quick charging port may be connected to the high-voltage distributor. A controller area network (CAN) and a 12 V power supply system may be connected to the low-voltage connector.

The electric motor 4 may be connected to the driving inverter. That is, the electric power output from the secondary battery 30 may be supplied to the electric motor 4 through the high-voltage connector, the high-voltage distributor, and the driving inverter.

### Configuration of Battery Pack

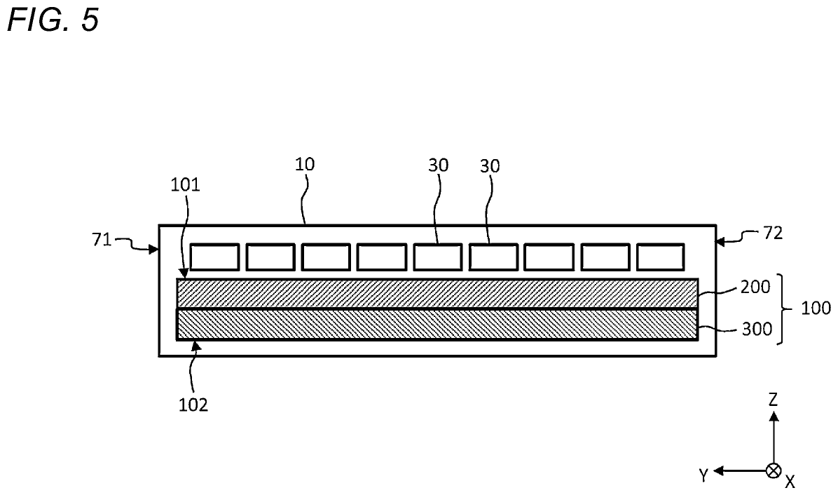

FIG. 4 is a perspective view illustrating a configuration example of the battery pack 10 according to the first embodiment. FIG. 5 is a cross-sectional view taken along a line A-A of the battery pack 10 shown in FIG. 4.

The battery pack 10 includes a housing 20, the secondary battery 30, and a heat exchange plate 100. The housing 20 accommodates the secondary battery 30 and the heat exchange plate 100.

The heat exchange plate 100 has, for example, a flat and substantially rectangular parallelepiped shape. The heat exchange plate 100 may be replaced with a heat exchanger. As shown in FIG. 5, the heat exchange plate 100 includes a first surface 101 disposed along a predetermined plane and a second surface 102 disposed along a predetermined plane. The predetermined plane may be a floor of the vehicle body 2. The members of the first surface 101 and the second surface 102 may be made of metal, for example, aluminum. However, the first surface 101 and the second surface 102 are not limited to metal and may be made of other materials.

The secondary battery 30 is disposed at a position opposite to the second surface 102 with reference to the first surface 101. That is, the second surface 102, the first surface 101, and the secondary battery 30 are arranged in this order from the floor of the vehicle body 2.

The heat exchange plate 100 includes a coolant layer 200 that allows a coolant to circulate between the first surface 101 and the second surface 102, and a refrigerant layer 300 that allows the refrigerant to circulate. The heat exchange plate 100 performs heat exchange between at least the secondary battery 30 and the coolant that moves in the coolant layer 200 via the first surface 101. Further, the heat exchange plate 100 performs heat exchange between at least the coolant that moves in the coolant layer 200 and the refrigerant that moves in the refrigerant layer 300. Examples of the coolant include an antifreezing solution containing ethylene glycol. An example of the refrigerant is a hydrofluorocarbon (HFC).

In the present embodiment, the heat exchange plate 100 is configured such that the coolant layer 200 is disposed on the refrigerant layer 300. However, the heat exchange plate 100 may be configured such that the refrigerant layer 300 is disposed on the coolant layer 200. The coolant layer 200 may be replaced with a coolant plate. The refrigerant layer 300 may be replaced with a refrigerant plate. Further, details of the configuration of the heat exchange plate 100, and details of configurations of the coolant layer 200 and the refrigerant layer 300 will be described later.

In the present embodiment, in the heat exchange plate 100, a portion in a predetermined direction (for example, a positive direction of the Y axis) is referred to as a first end portion 71, and a portion in a direction opposite to the first end portion 71 (for example, a negative direction of the Y axis) is referred to as a second end portion 72. The first end portion 71 may be a traveling direction side of the vehicle 1, and the second end portion 72 may be a side opposite to the traveling direction of the vehicle 1.

As shown in FIG. 4, a refrigerant input portion 301, a refrigerant output portion 302, a first coolant input and output portion 201, and a second coolant input and output portion 202 are disposed on the first end portion 71 of the heat exchange plate 100.

The refrigerant input portion 301 is a portion through which the refrigerant enters the refrigerant layer 300 from an outside of the heat exchange plate 100, and the refrigerant output portion 302 is a portion through which the refrigerant flows from the refrigerant layer 300 to the outside of the heat exchange plate 100.

The first coolant input and output portion 201 is a portion through which the coolant enters the coolant layer 200 from the outside of the heat exchange plate 100, and the second coolant input and output portion 202 is a portion through which the coolant flows from the coolant layer 200 to the outside of the heat exchange plate 100. Alternatively, the second coolant input and output portion 202 may be a portion through which the coolant enters the coolant layer 200 from the outside of the heat exchange plate 100, and the first coolant input and output portion 201 may be a portion through which the coolant flows from the coolant layer 200 to the outside of the heat exchange plate 100.

### Configuration of Heat Exchange Plate

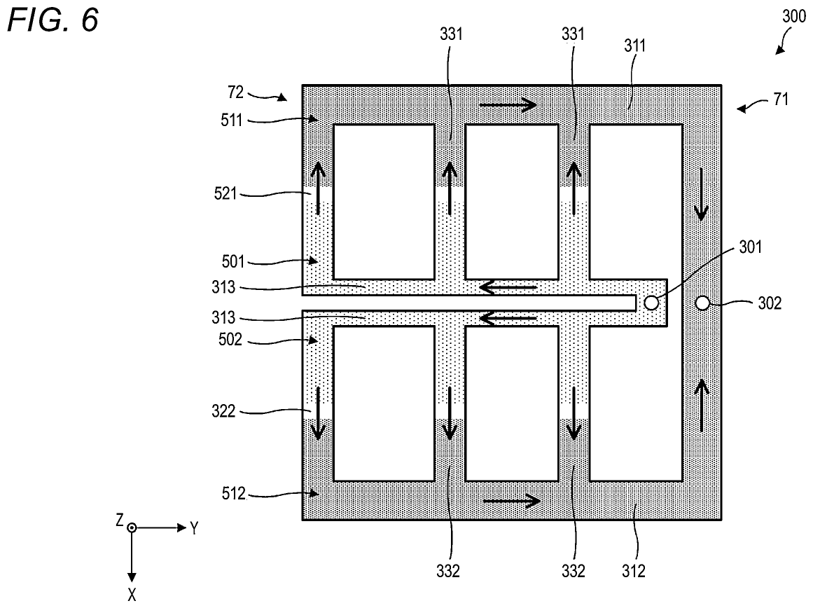

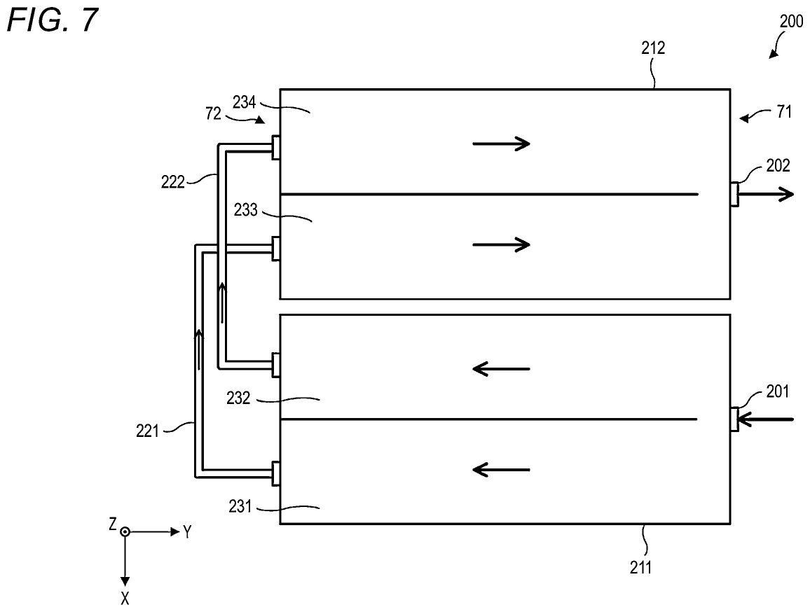

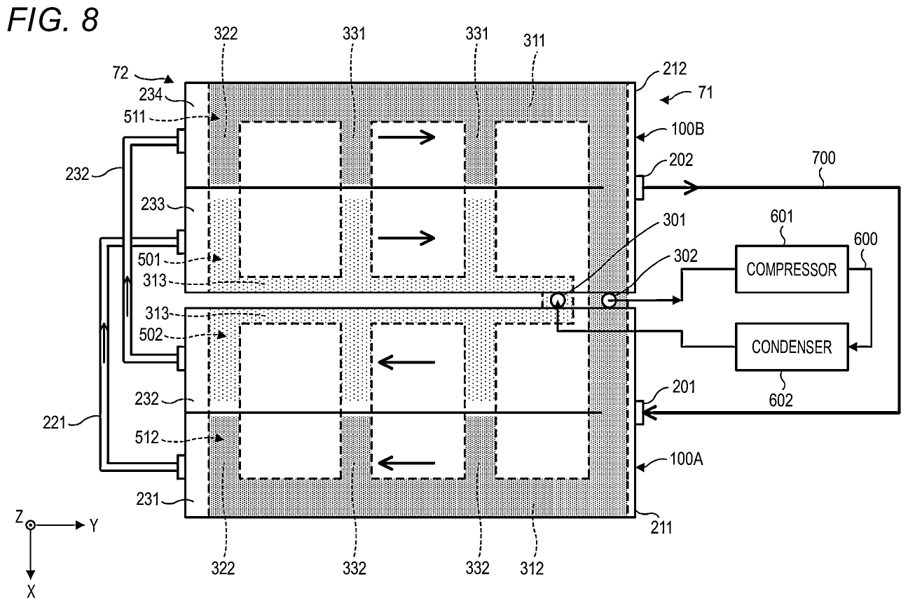

FIG. 6 is a plan view showing a configuration example of the refrigerant layer 300 according to the first embodiment. FIG. 7 is a plan view showing a configuration example of the coolant layer 200 according to the first embodiment. FIG. 8 is a plan view showing an example of a positional relationship between the refrigerant layer 300 and the coolant layer 200 according to the first embodiment.

First, the configuration of the refrigerant layer 300 will be described with reference to FIG. 6.

The refrigerant layer 300 includes the refrigerant input portion 301, the refrigerant output portion 302, a first refrigerant flow path 311, a second refrigerant flow path 312, a third refrigerant flow path 313, a first connection refrigerant flow path 321, and a second connection refrigerant flow path 322.

As described above, the refrigerant input portion 301 is disposed at the first end portion 71 of the heat exchange plate 100 and is a portion that allows the refrigerant to enter the refrigerant layer 300 of the heat exchange plate 100.

As described above, the refrigerant output portion 302 is disposed at the first end portion 71 of the heat exchange plate 100 and is a portion that allows the refrigerant to exit from the refrigerant layer 300 of the heat exchange plate 100.

The vehicle 1 includes a refrigerant circuit 600 which is connected to the refrigerant input portion 301 and the refrigerant output portion 302, which includes at least a compressor 601 and a condenser 602, and through which the refrigerant flows. Accordingly, the refrigerant exiting from the refrigerant output portion 302 is cooled through the compressor 601 and the condenser 602, and the cooled refrigerant enters the refrigerant input portion 301 to exchange heat with the coolant.

The first refrigerant flow path 311 is connected to the refrigerant output portion 302, and is disposed between the first surface 101 and the second surface 102 along a predetermined direction (for example, the Y axis direction).

The second refrigerant flow path 312 is connected to the refrigerant output portion 302, and is disposed between the first surface 101 and the second surface 102 along a predetermined direction (for example, a Y axis direction).

The third refrigerant flow path 313 is connected to the refrigerant input portion 301, and is disposed along a predetermined direction (for example, a Y axis direction) between the first surface 101 and the second surface 102 and between the first refrigerant flow path 311 and the second refrigerant flow path 312.

The first connection refrigerant flow path 321 connects the third refrigerant flow path 313 and the first refrigerant flow path 311 between the first surface 101 and the second surface 102.

The second connection refrigerant flow path 322 connects the third refrigerant flow path 313 and the second refrigerant flow path 312 between the first surface 101 and the second surface 102.

According to this configuration, the refrigerant that has entered the refrigerant layer 300 of the heat exchange plate 100 from the refrigerant input portion 301 can move to the refrigerant output portion 302 through the third refrigerant flow path 313, the first connection refrigerant flow path 321, and the first refrigerant flow path 311, and the refrigerant that has entered the heat exchange plate 100 from the refrigerant input portion 301 can move to the refrigerant output portion 302 via the third refrigerant flow path 313, the second connection refrigerant flow path 322, and the second refrigerant flow path 312.

The refrigerant layer 300 may further include at least one first branch refrigerant flow path 331 and at least one second branch refrigerant flow path 332. Each first branch refrigerant flow path 331 connects the third refrigerant flow path 313 and the first refrigerant flow path 311. Each second branch refrigerant flow path 332 connects the third refrigerant flow path 313 and the second refrigerant flow path 312.

According to this configuration, the refrigerant that has entered the heat exchange plate 100 from the refrigerant input portion 301 can move from the third refrigerant flow path 313 to the refrigerant output portion 302 through the first branch refrigerant flow path 331 and the first refrigerant flow path 311, and the refrigerant that has entered the heat exchange plate 100 from the refrigerant input portion 301 can move to the refrigerant output portion 302 through each second branch refrigerant flow path 332 and the second refrigerant flow path 312.

Since the refrigerant exchanges the heat with the coolant during the movement in the refrigerant flow passage, a temperature of the refrigerant tends to increase as the refrigerant becomes farther from the refrigerant input portion 301.

Accordingly, a temperature of the refrigerant flowing through the third refrigerant flow path 313 and the refrigerant flowing near the third refrigerant flow path 313 in each first branch refrigerant flow paths 331 tends to be lower than a temperature of the refrigerant flowing through the first refrigerant flow path 311 and the refrigerant flowing near the first refrigerant flow path 311 in each first branch refrigerant flow path 331. Therefore, in the present embodiment, the refrigerant flowing through the third refrigerant flow path 313 and the refrigerant flowing near the third refrigerant flow path 313 in each first branch refrigerant flow path 331 are referred to as a first low-temperature refrigerant 501 (for example, a lightly shaded portion in FIG. 6), and the refrigerant flowing through the first refrigerant flow path 311 and the refrigerant flowing near the first refrigerant flow path 311 in each first branch refrigerant flow path 331 are referred to as a first high-temperature refrigerant 511 (for example, a dark shaded portion in FIG. 6).

Similarly, a temperature of the refrigerant flowing through the third refrigerant flow path 313 and the refrigerant flowing near the third refrigerant flow path 313 in each second branch refrigerant flow path 332 tends to be lower than that of the refrigerant flowing through the second refrigerant flow path 312 and the refrigerant flowing near the second refrigerant flow path 312 in each second branch refrigerant flow path. Therefore, in the present embodiment, a refrigerant flowing through the third refrigerant flow path 313 and the refrigerant flowing near the third refrigerant flow path 313 in each second branch refrigerant flow path 332 are referred to as a second low-temperature refrigerant 502 (for example, a lightly shaded portion in FIG. 6), and the refrigerant flowing through the second refrigerant flow path 312 and the refrigerant flowing near the second refrigerant flow path 312 in each second branch refrigerant flow path 332 are referred to as a second high-temperature refrigerant 512 (for example, a dark shaded portion in FIG. 6).

However, the expressions “low-temperature” and “high-temperature” related to the refrigerant represent a relative temperature difference between the refrigerants, and do not have any comparative meaning to a temperature of the coolant or the like.

Next, the configuration of the coolant layer 200 will be described with reference to FIGS. 7 and 8.

The coolant layer 200 includes the first coolant input and output portion 201, the second coolant input and output portion 202, a first coolant flow path 211, a second coolant flow path 212, a first connection coolant flow path 221, and a second connection coolant flow path 222.

The first coolant input and output portion 201 is disposed at the first end portion 71, and the coolant is input to and output from the heat exchange plate 100.

The second coolant input and output portion 202 is disposed at the first end portion 71, and the coolant is input to and output from the heat exchange plate 100.

The vehicle 1 includes a coolant circuit 700 which is connected to the first coolant input and output portion 201 and the second coolant input and output portion 202 and in which the coolant circulates.

The first coolant flow path 211 is connected to the first coolant input and output portion 201, and is disposed between the first surface 101 and the second surface 102 along a predetermined direction (for example, the Y axis direction).

The second coolant flow path 212 is connected to the second coolant input and output portion 202, and is disposed between the first surface 101 and the second surface 102 along a predetermined direction (for example, the Y axis direction).

In plan view, the first coolant flow path 211 may overlap with at least a part of the second refrigerant flow path 312, at least a part of the second branch refrigerant flow paths 332, and at least a part of the third refrigerant flow path 313. Accordingly, the coolant flowing through the first coolant flow path 211 mainly performs heat exchange with the second low-temperature refrigerant 502 and the second high-temperature refrigerant 512 flowing through the refrigerant layer 300.

In plan view, the second coolant flow path 212 may overlap with at least a part of the first refrigerant flow path 311, at least a part of the first branch refrigerant flow paths 331, and at least a part of the third refrigerant flow path 313. Accordingly, the coolant flowing through the second coolant flow path 212 mainly performs heat exchange with the first low-temperature refrigerant 501 and the first high-temperature refrigerant 511 flowing through the refrigerant layer 300.

At the second end portion 72, the first connection coolant flow path 221 connects a part of the first coolant flow path 211 closer to the second refrigerant flow path 312 than the third refrigerant flow path 313 and a part of the second coolant flow path 212 closer to the third refrigerant flow path 313 than the first refrigerant flow path 311. The first connection coolant flow path may be formed by, for example, a hose.

At the second end portion 72, the second connection coolant flow path 222 connects a part of the first coolant flow path 211 closer to the third refrigerant flow path 313 than the second refrigerant flow path 312 and a part of the second coolant flow path 212 closer to the first refrigerant flow path 311 than the third refrigerant flow path 313. The second connection coolant flow path may be formed by, for example, a hose.

The coolant that has entered the heat exchange plate 100 from the first coolant input and output portion 201 can move from the first coolant flow path 211 through the first connection coolant flow path 221 and the second coolant flow path 212 to the second coolant input and output portion 202, and the coolant that has entered the heat exchange plate 100 from the first coolant input and output portion 201 can move from the first coolant flow path 211 through the second connection coolant flow path 222 and the second coolant flow path 212 to the second coolant input and output portion 202.

Accordingly, the coolant that flows through the first coolant flow path 211 and performs heat exchange mainly with the second high-temperature refrigerant 512 passes through the first connection coolant flow path 221 and performs heat exchange mainly with the first low-temperature refrigerant 501 in the second coolant flow path 212. In addition, the coolant that flows through the first coolant flow path 211 and performs heat exchange mainly with the second low-temperature refrigerant 502 passes through the second connection coolant flow path 222 and performs heat exchange mainly with the first high-temperature refrigerant 511 in the second coolant flow path 212. Accordingly, the coolant that flows through the first coolant flow path 211 and the second coolant flow path 212 performs heat exchange with the first low-temperature refrigerant 501, the first high-temperature refrigerant 511, the second low-temperature refrigerant 502, and the second high-temperature refrigerant 512 as a whole, so that the coolant layer 200 can achieve a coolant having little temperature unevenness overall. Accordingly, the coolant layer 200 can cool the secondary battery 30 more uniformly.

The first coolant flow path 211 may include a first branch flow path 231 and a second branch flow path 232 between the first surface 101 and the second surface 102.

The first branch flow path 231 is disposed closer to the second refrigerant flow path 312 than the third refrigerant flow path 313, and is connected to the first connection coolant flow path 221. In plan view, the first branch flow path 231 may overlap with at least a part of the second refrigerant flow path 312 and at least a part of the second branch refrigerant flow paths 332 near the second refrigerant flow path 312. Accordingly, the coolant that flows through the first branch flow path 231 mainly performs heat exchange with the second high-temperature refrigerant 512 in the refrigerant layer 300.

The second branch flow path 232 is disposed closer to the third refrigerant flow path 313 than the second refrigerant flow path 312, and is connected to the second connection coolant flow path 222. In plan view, the second branch flow path 232 may overlap with at least a part of the third refrigerant flow path 313 and at least a part of the second branch refrigerant flow paths 332 near the third refrigerant flow path 313. Accordingly, the coolant that flows through the second branch flow path 232 mainly performs heat exchange with the second low-temperature refrigerant 502 in the refrigerant layer 300.

The second coolant flow path 212 may include a third branch flow path 233 and a fourth branch flow path 234 between the first surface 101 and the second surface 102.

The third branch flow path 233 is disposed closer to the third refrigerant flow path 313 than the first refrigerant flow path 311, and is connected to the first connection coolant flow path. In plan view, the third branch flow path 233 may overlap with at least a part of the third refrigerant flow path 313 and at least a part of the first branch refrigerant flow paths 331 near the third refrigerant flow path 313. Accordingly, the coolant that flows through the third branch flow path 233 mainly performs heat exchange with the first low-temperature refrigerant 501 in the refrigerant layer 300.

The fourth branch flow path 234 is disposed closer to the first refrigerant flow path 311 than the third refrigerant flow path 313, and is connected to the second connection coolant flow path. In plan view, the fourth branch flow path 234 may overlap with at least a part of the first refrigerant flow path 311 and at least a part of the first branch refrigerant flow paths 331 near the third refrigerant flow path 313. Accordingly, the coolant that flows through the fourth branch flow path 234 mainly performs heat exchange with the first high-temperature refrigerant 511 in the refrigerant layer 300.

According to this configuration, the coolant that has entered the coolant layer 200 of the heat exchange plate 100 from the first coolant input and output portion 201 can move from the first branch flow path 231 through the first connection coolant flow path 221 and the third branch flow path 233 to the second coolant input and output portion 202, and the coolant that has entered the coolant layer 200 of the heat exchange plate 100 from the first coolant input and output portion 201 can move from the second branch flow path 232 through the second connection coolant flow path 222 and the fourth branch flow path 234 to the second coolant input and output portion 202.

Accordingly, the coolant that flows through the first branch flow path 231 and performs heat exchange mainly with the second high-temperature refrigerant 512 passes through the first connection coolant flow path 221 and performs heat exchange mainly with the first low-temperature refrigerant 501 in the third branch flow path 233. In addition, the coolant that flows through the second branch flow path 232 and performs heat exchange mainly with the second low-temperature refrigerant 502 passes through the second connection coolant flow path 222 and performs heat exchange mainly with the first high-temperature refrigerant 511 in the fourth branch flow path 234. Accordingly, the coolant flowing through the first branch flow path 231, the second branch flow path 232, the third branch flow path 233, and the fourth branch flow path 234 performs heat exchange with the second high-temperature refrigerant 512, the second low-temperature refrigerant 502, the first low-temperature refrigerant 501, and the first high-temperature refrigerant 511 as a whole, so that the coolant layer 200 can achieve a coolant having little temperature unevenness overall. Accordingly, the coolant layer 200 can cool the secondary battery 30 more uniformly.

Between the first surface 101 and the second surface 102, at least the first coolant flow path 211 and the second coolant flow path 212 may be disposed closer to the first surface 101 than the first refrigerant flow path 311, the second refrigerant flow path 312, and the third refrigerant flow path 313. According to this configuration, the refrigerant that moves in the refrigerant layer 300 can exchange heat with the coolant that moves in the coolant layer 200, and the coolant that moves in the coolant layer 200 can exchange heat with the secondary battery 30 via the first surface 101.

Alternatively, between the first surface 101 and the second surface 102, at least the first refrigerant flow path 311, the second refrigerant flow path 312, and the third refrigerant flow path 313 may be disposed closer to the first surface 101 than the first coolant flow path 211 and the second coolant flow path 212. According to this configuration, the coolant that moves in the coolant layer 200 can exchange heat with the refrigerant that moves in the refrigerant layer 300, and the refrigerant that moves in the refrigerant layer 300 can exchange heat with the secondary battery 30 via the first surface 101.

The heat exchange plate 100 may include a first heat exchange plate 100A and a second heat exchange plate 100B, the first coolant flow path 211 may be formed in the first heat exchange plate 100A, and the second coolant flow path 212 may be formed in the second heat exchange plate 100B. Further, the first heat exchange plate 100A and the second heat exchange plate 100B may be connected by the first connection coolant flow path 221 and the second connection coolant flow path 222. According to this configuration, a relatively large heat exchange plate 100 can be achieved by using the first heat exchange plate 100A and the second heat exchange plate 100B. In addition, manufacturing a large heat exchange plate 100 by combining the first heat exchange plate 100A and the second heat exchange plate 100B has great advantages in terms of manufacturing space, handling, and the like, rather than manufacturing one large heat exchange plate 100.

### Modification

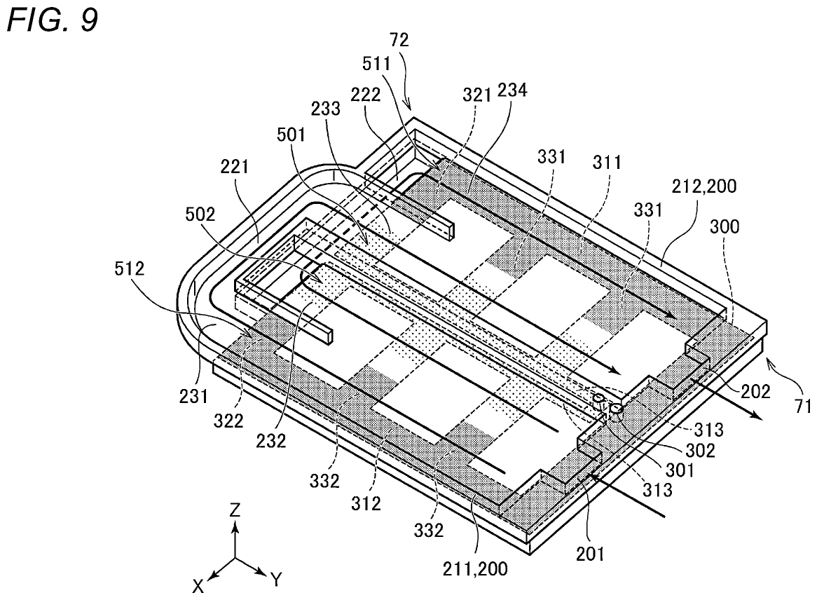

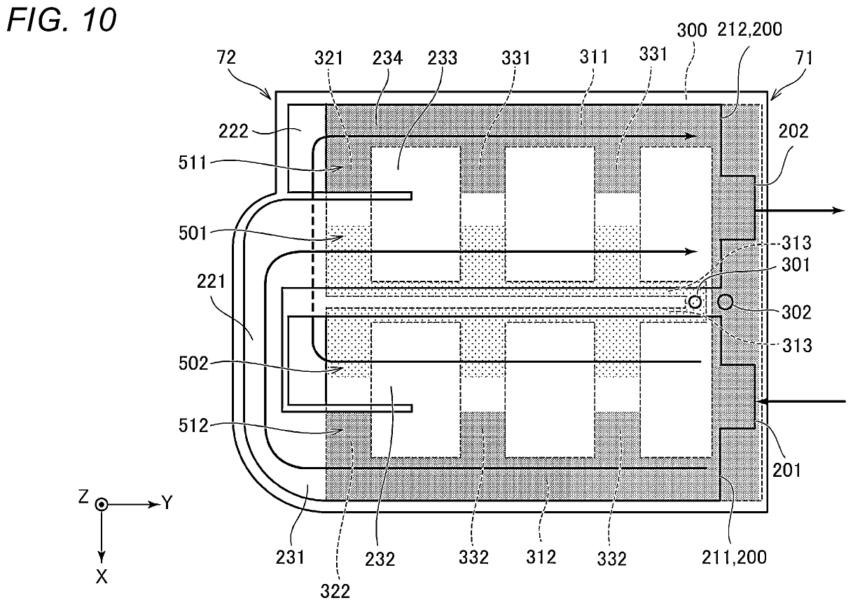

FIG. 9 is a perspective view showing a configuration example in which the first connection coolant flow path 221 and the second connection coolant flow path 222 cross three-dimensionally according to the first embodiment. FIG. 10 is a plan view showing a configuration example in which the first connection coolant flow path 221 and the second connection coolant flow path 222 cross three-dimensionally according to the first embodiment.

As shown in FIGS. 9 and 10, the first connection coolant flow path 221 and the second connection coolant flow path 222 may three-dimensionally cross each other. For example, as illustrated in FIGS. 9 and 10, the second connection coolant flow path 222 may pass below the first connection coolant flow path 221. In this case, the first connection coolant flow path 221 and the second connection coolant flow path 222 may be implemented by providing flow paths by a partition wall in the coolant layer 200 as shown in FIGS. 9 and 10, instead of hoses.

With this configuration as well, it is possible to achieve the same effects as those of the heat exchange plate 100 described above with reference to FIGS. 6, 7, and 8.

### Appendix of First Embodiment

The following techniques are disclosed from the above description of the first embodiment.

### Technique A1

A vehicle including:
a vehicle body;
a first wheel and a second wheel coupled to the vehicle body;
a secondary battery disposed along a predetermined plane in the vehicle body;
a heat exchange plate disposed along the predetermined plane in the vehicle body; and
an electric motor configured to drive at least the first wheel using electric power supplied from the secondary battery, in which
the vehicle is movable in a predetermined direction by the first wheel and the second wheel,
the heat exchange plate includes
   a first surface disposed along the predetermined plane and configured to perform heat exchange with the secondary battery,
   a second surface disposed along the predetermined plane and opposite to the first surface,
   a first end portion in the predetermined direction,
   a second end portion opposite to the first end portion in the predetermined direction,
   a refrigerant input portion disposed at the first end portion and configured to allow a refrigerant to enter the heat exchange plate,
   a refrigerant output portion disposed at the first end portion and configured to allow the refrigerant to exit the heat exchange plate,
   a first refrigerant flow path connected to the refrigerant output portion and disposed along the predetermined direction between the first surface and the second surface,
   a second refrigerant flow path connected to the refrigerant output portion and disposed along the predetermined direction between the first surface and the second surface,
   a third refrigerant flow path connected to the refrigerant input portion and disposed along the predetermined direction between the first surface and the second surface and between the first refrigerant flow path and the second refrigerant flow path,
   a first connection refrigerant flow path connecting the third refrigerant flow path and the first refrigerant flow path between the first surface and the second surface, and
   a second connection refrigerant flow path connecting the third refrigerant flow path and the second refrigerant flow path between the first surface and the second surface,
the refrigerant that has entered the heat exchange plate from the refrigerant input portion is movable from the third refrigerant flow path through the first connection refrigerant flow path and the first refrigerant flow path to the refrigerant output portion, and the refrigerant that has entered the heat exchange plate from the refrigerant input portion is movable from the third refrigerant flow path through the second connection refrigerant flow path and the second refrigerant flow path to the refrigerant output portion,
the heat exchange plate further includes
   a first coolant input and output portion disposed at the first end portion and configured to allow a coolant to be input to and output from the heat exchange plate,
   a second coolant input and output portion disposed at the first end portion and configured to allow the coolant to be input to and output from the heat exchange plate,
   a first coolant flow path connected to the first coolant input and output portion and disposed along the predetermined direction between the first surface and the second surface,
   a second coolant flow path connected to the second coolant input and output portion and disposed along the predetermined direction between the first surface and the second surface,
   a first connection coolant flow path connecting a part of the first coolant flow path closer to the second refrigerant flow path than the third refrigerant flow path and a part of the second coolant flow path closer to the third refrigerant flow path than the first refrigerant flow path at the second end portion, and
   a second connection coolant flow path connecting a part of the first coolant flow path closer to the third refrigerant flow path than the second refrigerant flow path and a part of the second coolant flow path closer to the first refrigerant flow path than the third refrigerant flow path at the second end portion, and
the coolant that has entered the heat exchange plate from the first coolant input and output portion is movable from the first coolant flow path through the first connection coolant flow path and the second coolant flow path to the second coolant input and output portion, and the coolant that has entered the heat exchange plate from the first coolant input and output portion is movable from the first coolant flow path through the second connection coolant flow path and the second coolant flow path to the second coolant input and output portion.

### Technique A2

The vehicle according to the technique A1, in which
the first coolant flow path includes, between the first surface and the second surface,
   a first branch flow path disposed closer to the second refrigerant flow path than the third refrigerant flow path and connected to the first connection coolant flow path, and
   a second branch flow path disposed closer to the third refrigerant flow path than the second refrigerant flow path and connected to the second connection coolant flow path, and
the second coolant flow path includes, between the first surface and the second surface,
   a third branch flow path disposed closer to the third refrigerant flow path than the first refrigerant flow path and connected to the first connection coolant flow path, and
   a fourth branch flow path disposed closer to the first refrigerant flow path than the third refrigerant flow path and connected to the second connection coolant flow path.

### Technique A3

The vehicle according to the technique A1 or A2, in which
the heat exchange plate further includes
   at least one first branch refrigerant flow path connecting the third refrigerant flow path and the first refrigerant flow path, and
   at least one second branch refrigerant flow path connecting the third refrigerant flow path and the second refrigerant flow path.

### Technique A4

The vehicle according to any one of the techniques A1 to A3, in which
between the first surface and the second surface, at least the first coolant flow path and the second coolant flow path are disposed closer to the first surface than the first refrigerant flow path, the second refrigerant flow path, and the third refrigerant flow path.

### Technique A5

The vehicle according to any one of the techniques A1 to A4, in which
between the first surface and the second surface, at least the first refrigerant flow path, the second refrigerant flow path, and the third refrigerant flow path are disposed closer to the first surface than the first coolant flow path and the second coolant flow path.

### Technique A6

The vehicle according to any one of the techniques A1 to A5, in which
each of the first connection coolant flow path and the second connection coolant flow path is formed by a hose.

### Technique A7

The vehicle according to the technique A6, in which
the heat exchange plate includes a first heat exchange plate and a second heat exchange plate,
the first coolant flow path is formed in the first heat exchange plate, and
the second coolant flow path is formed in the second heat exchange plate.

### Technique A8

The vehicle according to any one of the techniques A1 to A5, in which
the first connection coolant flow path and the second connection coolant flow path cross three-dimensionally.

### Technique A9

The vehicle according to any one of the techniques A1 to A8, further including:
a coolant circuit which is connected to the first coolant input and output portion and the second coolant input and output portion and in which the coolant circulates.

### Technique A10

The vehicle according to any one of the techniques A1 to A9, further including:
a refrigerant circuit which is connected to the refrigerant input portion and the refrigerant output portion, which includes at least a compressor and a condenser, and in which the refrigerant flows.

### Technique A11

A heat exchange plate mountable on a vehicle movable in a predetermined direction by a first wheel and a second wheel,
the vehicle including
a vehicle body,
the first wheel and the second wheel coupled to the vehicle body,
a secondary battery disposed along a predetermined plane in the vehicle body, and
an electric motor configured to drive at least the first wheel using electric power supplied from the secondary battery,
the heat exchange plate including:
a first surface disposed along the predetermined plane and configured to perform heat exchange with the secondary battery;
a second surface disposed along the predetermined plane and opposite to the first surface;
a first end portion in the predetermined direction;
a second end portion opposite to the first end portion in the predetermined direction;
a refrigerant input portion disposed at the first end portion and configured to allow a refrigerant to enter the heat exchange plate;
a refrigerant output portion disposed at the first end portion and configured to allow the refrigerant to exit the heat exchange plate;
a first refrigerant flow path connected to the refrigerant output portion and disposed along the predetermined direction between the first surface and the second surface;
a second refrigerant flow path connected to the refrigerant output portion and disposed along the predetermined direction between the first surface and the second surface;
a third refrigerant flow path connected to the refrigerant input portion and disposed along the predetermined direction between the first surface and the second surface and between the first refrigerant flow path and the second refrigerant flow path;
a first connection refrigerant flow path connecting the third refrigerant flow path and the first refrigerant flow path between the first surface and the second surface; and
a second connection refrigerant flow path connecting the third refrigerant flow path and the second refrigerant flow path between the first surface and the second surface, in which
the refrigerant that has entered the heat exchange plate from the refrigerant input portion is movable from the third refrigerant flow path through the first connection refrigerant flow path and the first refrigerant flow path to the refrigerant output portion, and the refrigerant that has entered the heat exchange plate from the refrigerant input portion is movable from the third refrigerant flow path through the second connection refrigerant flow path and the second refrigerant flow path to the refrigerant output portion,
the heat exchange plate further includes:
   a first coolant input and output portion disposed at the first end portion and configured to allow a coolant to be input to and output from the heat exchange plate;
   a second coolant input and output portion disposed at the first end portion and configured to allow the coolant to be input to and output from the heat exchange plate;
   a first coolant flow path connected to the first coolant input and output portion and disposed along the predetermined direction between the first surface and the second surface;
   a second coolant flow path connected to the second coolant input and output portion and disposed along the predetermined direction between the first surface and the second surface;
   a first connection coolant flow path connecting a part of the first coolant flow path closer to the second refrigerant flow path than the third refrigerant flow path and a part of the second coolant flow path closer to the third refrigerant flow path than the first refrigerant flow path at the second end portion; and
   a second connection coolant flow path connecting a part of the first coolant flow path closer to the third refrigerant flow path than the second refrigerant flow path and a part of the second coolant flow path closer to the first refrigerant flow path than the third refrigerant flow path at the second end portion, and
the coolant that has entered the heat exchange plate from the first coolant input and output portion is movable from the first coolant flow path through the first connection coolant flow path and the second coolant flow path to the second coolant input and output portion, and the coolant that has entered the heat exchange plate from the first coolant input and output portion is movable from the first coolant flow path through the second connection coolant flow path and the second coolant flow path to the second coolant input and output portion.

### Technique A12

The heat exchange plate according to the technique A11, in which
the first coolant flow path includes, between the first surface and the second surface,
   a first branch flow path disposed closer to the second refrigerant flow path than the third refrigerant flow path and connected to the first connection coolant flow path, and
   a second branch flow path disposed closer to the third refrigerant flow path than the second refrigerant flow path and connected to the second connection coolant flow path, and
the second coolant flow path includes, between the first surface and the second surface,
   a third branch flow path disposed closer to the third refrigerant flow path than the first refrigerant flow path and connected to the first connection coolant flow path, and
   a fourth branch flow path disposed closer to the first refrigerant flow path than the third refrigerant flow path and connected to the second connection coolant flow path.

### Technique A13

The heat exchange plate according to the technique A11 or A12, further including:
at least one first branch refrigerant flow path connecting the third refrigerant flow path and the first refrigerant flow path; and
at least one second branch refrigerant flow path connecting the third refrigerant flow path and the second refrigerant flow path.

### Technique A14

The heat exchange plate according to any one of the techniques A11 to A13, in which
between the first surface and the second surface, at least the first coolant flow path and the second coolant flow path are disposed closer to the first surface than the first refrigerant flow path, the second refrigerant flow path, and the third refrigerant flow path.

### Technique A15

The heat exchange plate according to any one of the techniques A11 to A14, in which
between the first surface and the second surface, at least the first refrigerant flow path, the second refrigerant flow path, and the third refrigerant flow path are disposed closer to the first surface than the first coolant flow path and the second coolant flow path.

### Technique A16

The heat exchange plate according to any one of the techniques A11 to A15, in which
each of the first connection coolant flow path and the second connection coolant flow path is formed by a hose.

### Technique A17

The heat exchange plate according to the technique A16, in which
the heat exchange plate includes a first heat exchange plate and a second heat exchange plate,
the first coolant flow path is formed in the first heat exchange plate, and
the second coolant flow path is formed in the second heat exchange plate.

### Technique A18

The heat exchange plate according to any one of the techniques A11 to A15, in which
the first connection coolant flow path and the second connection coolant flow path cross three-dimensionally.

### Technique A19

The heat exchange plate according to any one of the techniques A11 to A18, in which
a coolant circuit in which the coolant circulates and which is provided in the vehicle body is connectable to the first coolant input and output portion and the second coolant input and output portion.

### Technique A20

The heat exchange plate according to any one of the techniques A11 to A19, in which
a refrigerant circuit which includes at least a compressor and a condenser, in which the refrigerant flows, and which is provided in the vehicle body is connectable to the refrigerant input portion and the refrigerant output portion.

### Second Embodiment

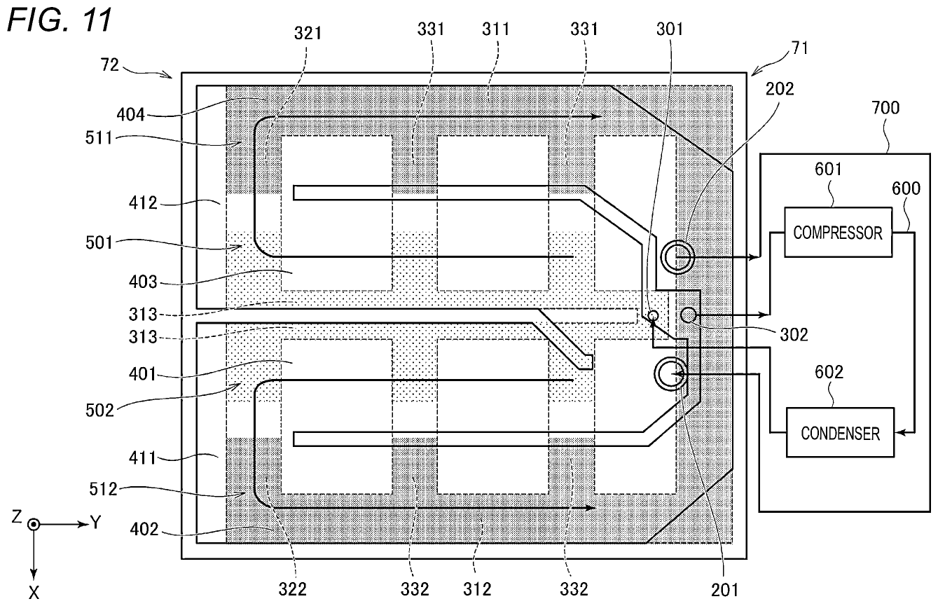

FIG. 11 is a plan view showing a configuration example of the heat exchange plate 100 according to a second embodiment.

A refrigerant layer 300 in the second embodiment may have the same configuration as the refrigerant layer 300 in the first embodiment. Accordingly, a description of the refrigerant layer 300 is omitted here.

The vehicle 1 may include the refrigerant circuit 600 which is connected to the refrigerant input portion 301 and the refrigerant output portion 302, which includes at least the compressor 601 and the condenser 602, and through which the refrigerant flows. Accordingly, the refrigerant exiting from the refrigerant output portion 302 is cooled through the compressor 601 and the condenser 602, and the cooled refrigerant enters the refrigerant input portion 301 to exchange heat with the coolant.

The vehicle 1 includes the coolant circuit 700 which is connected to the first coolant input and output portion 201 and the second coolant input and output portion 202 and in which the coolant circulates.

The coolant layer 200 includes the first coolant input and output portion 201, the second coolant input and output portion 202, a first coolant flow path 401, a second coolant flow path 402, a third coolant flow path 403, a fourth coolant flow path 404, a first connection coolant flow path 411, and a second connection coolant flow path 412.

The first coolant input and output portion 201 is disposed at the first end portion 71, and the coolant is input to and output from the heat exchange plate 100.

The second coolant input and output portion 202 is disposed at the first end portion 71, and the coolant is input to and output from the heat exchange plate 100.

The first coolant flow path 401 is connected to the first coolant input and output portion 201, and is formed closer to the third refrigerant flow path 313 than the second refrigerant flow path 312 along a predetermined direction (for example, the Y direction) between the first surface 101 and the second surface 102. In plan view, the first coolant flow path 401 may overlap with at least a part of the third refrigerant flow path 313 and at least a part of the second branch refrigerant flow paths 332 near the third refrigerant flow path 313. Accordingly, the coolant flowing through the first coolant flow path 401 mainly performs heat exchange with the second low-temperature refrigerant 502 in the refrigerant layer 300.

The second coolant flow path 402 is connected to the second coolant input and output portion 202, and is formed closer to the second refrigerant flow path 312 than the third refrigerant flow path 313 along a predetermined direction (for example, the Y axis direction) between the first surface 101 and the second surface 102. In plan view, the second coolant flow path 402 may overlap with at least a part of the second refrigerant flow path 312 and at least a part of the second branch refrigerant flow paths 332 near the second refrigerant flow path 312. Accordingly, the coolant flowing through the second coolant flow path 402 mainly performs heat exchange with the second high-temperature refrigerant 512 in the refrigerant layer 300.

The third coolant flow path 403 is connected to the first coolant input and output portion 201, and is formed closer to the third refrigerant flow path 313 than the first refrigerant flow path 311 along a predetermined direction (for example, the Y axis direction) between the first surface 101 and the second surface 102. In plan view, the third coolant flow path 403 may overlap with at least a part of the third refrigerant flow path 313 and at least a part of the first branch refrigerant flow paths 331 near the third refrigerant flow path 313. Accordingly, the coolant flowing through the third coolant flow path 403 mainly performs heat exchange with the first low-temperature refrigerant 501 in the refrigerant layer 300.

The fourth coolant flow path 404 is connected to the second coolant input and output portion 202, and is formed closer to the first refrigerant flow path 311 than the third refrigerant flow path 313 along a predetermined direction (for example, the Y axis direction) between the first surface 101 and the second surface 102. In plan view, the fourth coolant flow path 404 may overlap with at least a part of the first refrigerant flow path 311 and at least a part of the first branch refrigerant flow paths 331 near the first refrigerant flow path 311. Accordingly, the coolant flowing through the fourth coolant flow path 404 mainly performs heat exchange with the first high-temperature refrigerant 511 in the refrigerant layer 300.

The first connection coolant flow path 411 connects the first coolant flow path 401 and the second coolant flow path 402 at the second end portion 72.

The second connection coolant flow path 412 connects the third coolant flow path 403 and the fourth coolant flow path 404 at the second end portion 72.

According to this configuration, the coolant that has entered the coolant layer 200 of the heat exchange plate 100 from the first coolant input and output portion 201 can move from the first coolant flow path 401 through the first connection coolant flow path 411 and the second connection coolant flow path 412 to the second coolant input and output portion 202, and the coolant that has entered the coolant layer 200 of the heat exchange plate 100 from the first coolant input and output portion 201 can move from the third coolant flow path 403 through the second connection coolant flow path 412 and the fourth coolant flow path 404 to the second coolant input and output portion 202.

Accordingly, the coolant that flows through the first coolant flow path 401 and performs heat exchange mainly with the second low-temperature refrigerant 502 passes through the first connection coolant flow path 411 and performs heat exchange mainly with the second high-temperature refrigerant 512 in the second coolant flow path 402. In addition, the coolant that flows through the third coolant flow path 403 and performs heat exchange mainly with the first low-temperature refrigerant 501 passes through the second connection coolant flow path 412 and performs heat exchange mainly with the first high-temperature refrigerant 511 in the fourth coolant flow path 404. Accordingly, the coolant flowing through the first coolant flow path 401, the second coolant flow path 402, the third coolant flow path 403, and the fourth coolant flow path 404 performs heat exchange with the second low-temperature refrigerant 502, the second high-temperature refrigerant 512, the first low-temperature refrigerant 501, and the first high-temperature refrigerant 511 as a whole, so that the coolant layer 200 can achieve a coolant having little temperature unevenness overall. Accordingly, the coolant layer 200 can cool the secondary battery 30 more uniformly.

Between the first surface 101 and the second surface 102, at least the first coolant flow path 401, the second coolant flow path 402, the third coolant flow path 403, and the fourth coolant flow path 404 may be disposed closer to the first surface 101 than the first refrigerant flow path 311, the second refrigerant flow path 312, and the third refrigerant flow path 313. According to this configuration, the refrigerant that moves in the refrigerant layer 300 can exchange heat with the coolant that moves in the coolant layer 200, and the coolant that moves in the coolant layer 200 can exchange heat with the secondary battery 30 via the first surface 101.

Alternatively, between the first surface 101 and the second surface 102, at least the first refrigerant flow path 311, the second refrigerant flow path 312, and the third refrigerant flow path 313 may be disposed closer to the first surface 101 than the first coolant flow path 401, the second coolant flow path 402, the third coolant flow path 403, and the fourth coolant flow path 404. According to this configuration, the coolant that moves in the coolant layer 200 can exchange heat with the refrigerant that moves in the refrigerant layer 300, and the refrigerant that moves in the refrigerant layer 300 can exchange heat with the secondary battery 30 via the first surface 101.

Next, a case in which a circulation direction of the coolant is switched will be described.

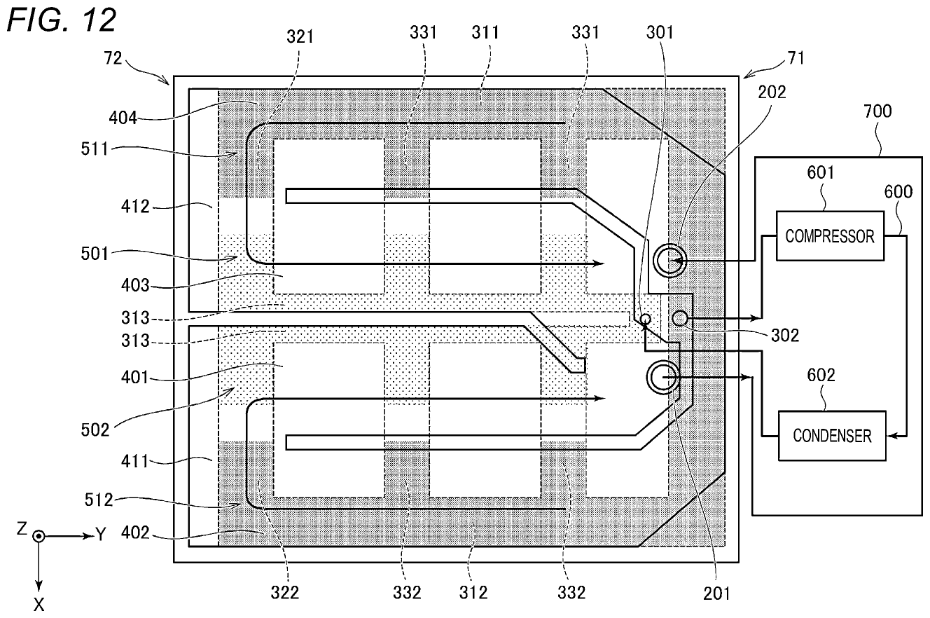

FIG. 12 is a diagram showing a case in which the circulation direction of the coolant is switched in the heat exchange plate 100 according to the second embodiment. FIG. 12 is different from FIG. 11 in the circulation direction of the coolant.

When a temperature of the coolant flowing through the coolant circuit 700 is lower than a temperature of the outside air, the coolant is warmed by the outside air while flowing through the coolant circuit 700. Therefore, in the second embodiment, when the temperature of the coolant flowing through the coolant circuit 700 is lower than the temperature of the outside air, as illustrated in FIG. 11, the coolant is input to the first coolant input and output portion 201 and is output from the second coolant input and output portion 202. Accordingly, the coolant that moves through the first coolant flow path 401 and the third coolant flow path 403 is warmed by the outside air, but is cooled sufficiently by the first low-temperature refrigerant 501 and the second low-temperature refrigerant 502, and therefore the coolant can cool the secondary battery 30. In addition, the coolant that moves through the second coolant flow path 212 and the fourth coolant flow path is sufficiently cooled by the second low-temperature refrigerant 502 and the second low-temperature refrigerant 502 while moving in the first coolant flow path 211 and the third coolant flow path in the preceding stage, and thus the secondary battery 30 can be cooled. That is, the coolant layer 200 can uniformly cool the secondary battery 30.

On the other hand, when the temperature of the coolant flowing through the coolant circuit 700 is higher than the temperature of the outside air, the coolant is cooled by the outside air while flowing through the coolant circuit 700. Therefore, in the second embodiment, when the temperature of the coolant flowing through the coolant circuit 700 is higher than the temperature of the outside air, as illustrated in FIG. 12, the coolant is input to the second coolant input and output portion 202 and is output from the first coolant input and output portion 201. Accordingly, the coolant that enters the second coolant flow path 402 and the fourth coolant flow path 404 from the second coolant input and output portion 202 is cooled by the outside air, so that the secondary battery 30 can be cooled while the coolant moves through the second coolant flow path 402 and the fourth coolant flow path 404. Further, the coolants that move through the first coolant flow path 401 and the third coolant flow path 403 is sufficiently cooled by the second low-temperature refrigerant 502 and the first low-temperature refrigerant 501, respectively, so that the secondary battery 30 can be cooled. That is, the coolant layer 200 can uniformly cool the secondary battery 30.

A process of determining the circulation direction of the coolant in the coolant circuit 700 may be performed by an electronic control unit (ECU) or the like in the vehicle 1. For example, the ECU acquires a measurement result of the temperature of the coolant flowing through the coolant circuit 700 and a measurement result of the temperature of the outside air. Further, when the measurement result of the temperature of the coolant flowing through the coolant circuit 700 is lower than the measurement result of the temperature of the outside air, the ECU switches the circulation direction so that the coolant is input to the first coolant input and output portion 201 and output from the second coolant input and output portion 202, and when the measurement result of the temperature of the coolant flowing through the coolant circuit 700 is higher than the measurement result of the temperature of the outside air, the ECU switches the circulation direction so that the coolant is input to the second coolant input and output portion 202 and output from the first coolant input and output portion 201.

### Appendix of Second Embodiment

The following techniques are disclosed from the above description of the second embodiment.

### Technique B1

A vehicle including:
a vehicle body;
a first wheel and a second wheel coupled to the vehicle body;
a secondary battery disposed along a predetermined plane in the vehicle body;
a heat exchange plate disposed along the predetermined plane in the vehicle body; and
an electric motor configured to drive at least the first wheel using electric power supplied from the secondary battery, in which
the vehicle is movable in a predetermined direction by the first wheel and the second wheel,
the heat exchange plate includes
   a first surface disposed along the predetermined plane and configured to perform heat exchange with the secondary battery,
   a second surface disposed along the predetermined plane and opposite to the first surface,
   a first end portion in the predetermined direction,
   a second end portion opposite to the first end portion in the predetermined direction,
   a refrigerant input portion disposed at the first end portion and configured to allow a refrigerant to enter the heat exchange plate,
   a refrigerant output portion disposed at the first end portion and configured to allow the refrigerant to exit the heat exchange plate,
   a first refrigerant flow path connected to the refrigerant output portion and disposed along the predetermined direction between the first surface and the second surface,
   a second refrigerant flow path connected to the refrigerant output portion and disposed along the predetermined direction between the first surface and the second surface,
   a third refrigerant flow path connected to the refrigerant input portion and disposed along the predetermined direction between the first surface and the second surface and between the first refrigerant flow path and the second refrigerant flow path,
   a first connection refrigerant flow path connecting the third refrigerant flow path and the first refrigerant flow path between the first surface and the second surface, and
   a second connection refrigerant flow path connecting the third refrigerant flow path and the second refrigerant flow path between the first surface and the second surface,
the refrigerant that has entered the heat exchange plate from the refrigerant input portion is movable from the third refrigerant flow path through the first connection refrigerant flow path and the first refrigerant flow path to the refrigerant output portion, and the refrigerant that has entered the heat exchange plate from the refrigerant input portion is movable from the third refrigerant flow path through the second connection refrigerant flow path and the second refrigerant flow path to the refrigerant output portion,
the heat exchange plate further includes
   a first coolant input and output portion disposed at the first end portion and configured to allow a coolant to be input to and output from the heat exchange plate,
   a second coolant input and output portion disposed at the first end portion and configured to allow the coolant to be input to and output from the heat exchange plate,
   a first coolant flow path connected to the first coolant input and output portion, formed along the predetermined direction between the first surface and the second surface, and closer to the third refrigerant flow path than the second refrigerant flow path,
   a second coolant flow path connected to the second coolant input and output portion, formed along the predetermined direction between the first surface and the second surface, and closer to the second refrigerant flow path than the third refrigerant flow path,
   a third coolant flow path connected to the first coolant input and output portion, formed along the predetermined direction between the first surface and the second surface, and closer to the third refrigerant flow path than the first refrigerant flow path,
   a fourth coolant flow path connected to the second coolant input and output portion, formed along the predetermined direction between the first surface and the second surface, and closer to the first refrigerant flow path than the third refrigerant flow path,
   a first connection coolant flow path connecting the first coolant flow path and the second coolant flow path at the second end portion, and
   a second connection coolant flow path connecting the third coolant flow path and the fourth coolant flow path at the second end portion, and
the coolant that has entered the heat exchange plate from the first coolant input and output portion is movable from the first coolant flow path through the first connection coolant flow path and the second coolant flow path to the second coolant input and output portion, and the coolant that has entered the heat exchange plate from the first coolant input and output portion is movable from the third coolant flow path through the second connection coolant flow path and the fourth coolant flow path to the second coolant input and output portion.

### Technique B2

The vehicle according to the technique B1, in which
between the first surface and the second surface, at least the first coolant flow path, the second coolant flow path, the third coolant flow path, and the fourth coolant flow path are disposed closer to the first surface than the first refrigerant flow path, the second refrigerant flow path, and the third refrigerant flow path.

### Technique B3

The vehicle according to the technique B1 or B2, in which
between the first surface and the second surface, at least the first refrigerant flow path, the second refrigerant flow path, and the third refrigerant flow path are disposed closer to the first surface than the first coolant flow path, the second coolant flow path, the third coolant flow path, and the fourth coolant flow path.

### Technique B4

The vehicle according to any one of the techniques B1 to B3, further including:
a coolant circuit which is connected to the first coolant input and output portion and the second coolant input and output portion and in which the coolant circulates.

### Technique B5

The vehicle according to the technique B4, in which
when a temperature of the coolant flowing through the coolant circuit is lower than a temperature of outside air, the coolant is input to the first coolant input and output portion and output from the second coolant input and output portion.

### Technique B6

The vehicle according to the technique B4 or B5, in which
when the temperature of the coolant flowing through the coolant circuit is higher than the temperature of the outside air, the coolant is input to the second coolant input and output portion and output from the first coolant input and output portion.

### Technique B7

The vehicle according to any one of the techniques B1 to B6, in which
the heat exchange plate further includes
   at least one first branch refrigerant flow path connecting the third refrigerant flow path and the first refrigerant flow path, and
   at least one second branch refrigerant flow path connecting the third refrigerant flow path and the second refrigerant flow path.

### Technique B8

The vehicle according to any one of the techniques B1 to B7, further including:
a refrigerant circuit which is connected to the refrigerant input portion and the refrigerant output portion, which includes at least a compressor and a condenser, and in which the refrigerant flows.

### Technique B9

A heat exchange plate mountable on a vehicle movable in a predetermined direction by a first wheel and a second wheel,
the vehicle including
a vehicle body,
the first wheel and the second wheel coupled to the vehicle body,
a secondary battery disposed along a predetermined plane in the vehicle body, and
an electric motor configured to drive at least the first wheel using electric power supplied from the secondary battery,
the heat exchange plate including:
a first surface disposed along the predetermined plane and configured to perform heat exchange with the secondary battery;
a second surface disposed along the predetermined plane and opposite to the first surface;
a first end portion in the predetermined direction;
a second end portion opposite to the first end portion in the predetermined direction;
a refrigerant input portion disposed at the first end portion and configured to allow a refrigerant to enter the heat exchange plate;
a refrigerant output portion disposed at the first end portion and configured to allow the refrigerant to exit the heat exchange plate;
a first refrigerant flow path connected to the refrigerant output portion and disposed along the predetermined direction between the first surface and the second surface;
a second refrigerant flow path connected to the refrigerant output portion and disposed along the predetermined direction between the first surface and the second surface;
a third refrigerant flow path connected to the refrigerant input portion and disposed along the predetermined direction between the first surface and the second surface and between the first refrigerant flow path and the second refrigerant flow path;
a first connection refrigerant flow path connecting the third refrigerant flow path and the first refrigerant flow path between the first surface and the second surface; and
a second connection refrigerant flow path connecting the third refrigerant flow path and the second refrigerant flow path between the first surface and the second surface, in which
the refrigerant that has entered the heat exchange plate from the refrigerant input portion is movable from the third refrigerant flow path through the first connection refrigerant flow path and the first refrigerant flow path to the refrigerant output portion, and the refrigerant that has entered the heat exchange plate from the refrigerant input portion is movable from the third refrigerant flow path through the second connection refrigerant flow path and the second refrigerant flow path to the refrigerant output portion,
the heat exchange plate further includes:
   a first coolant input and output portion disposed at the first end portion and configured to allow a coolant to be input to and output from the heat exchange plate;
   a second coolant input and output portion disposed at the first end portion and configured to allow the coolant to be input to and output from the heat exchange plate;
   a first coolant flow path connected to the first coolant input and output portion, formed along the predetermined direction between the first surface and the second surface, and closer to the third refrigerant flow path than the second refrigerant flow path;
   a second coolant flow path connected to the second coolant input and output portion, formed along the predetermined direction between the first surface and the second surface, and closer to the second refrigerant flow path than the third refrigerant flow path;
   a third coolant flow path connected to the first coolant input and output portion, formed along the predetermined direction between the first surface and the second surface, and closer to the third refrigerant flow path than the first refrigerant flow path;
   a fourth coolant flow path connected to the second coolant input and output portion, formed along the predetermined direction between the first surface and the second surface, and closer to the first refrigerant flow path than the third refrigerant flow path;
   a first connection coolant flow path connecting the first coolant flow path and the second coolant flow path at the second end portion; and
   a second connection coolant flow path connecting the third coolant flow path and the fourth coolant flow path at the second end portion, and
the coolant that has entered the heat exchange plate from the first coolant input and output portion is movable from the first coolant flow path through the first connection coolant flow path and the second coolant flow path to the second coolant input and output portion, and the coolant that has entered the heat exchange plate from the first coolant input and output portion is movable from the third coolant flow path through the second connection coolant flow path and the fourth coolant flow path to the second coolant input and output portion.

### Technique B10

The heat exchange plate according to the technique B9, in which
between the first surface and the second surface, at least the first coolant flow path, the second coolant flow path, the third coolant flow path, and the fourth coolant flow path are disposed closer to the first surface than the first refrigerant flow path, the second refrigerant flow path, and the third refrigerant flow path.

### Technique B11

The heat exchange plate according to the technique B9 or B10, in which
between the first surface and the second surface, at least the first refrigerant flow path, the second refrigerant flow path, and the third refrigerant flow path are disposed closer to the first surface than the first coolant flow path, the second coolant flow path, the third coolant flow path, and the fourth coolant flow path.

### Technique B12

The heat exchange plate according to any one of the techniques B9 to B11, in which
a coolant circuit in which the coolant circulates and which is provided on the vehicle body is connectable to the first coolant input and output portion and the second coolant input and output portion.

### Technique B13

The heat exchange plate according to the technique B12, in which
when a temperature of the coolant flowing through the coolant circuit is lower than a temperature of outside air, the coolant is input to the first coolant input and output portion and output from the second coolant input and output portion.

### Technique B14

The heat exchange plate according to the technique B12 or B13, in which
when the temperature of the coolant flowing through the coolant circuit is higher than the temperature of the outside air, the coolant is input to the second coolant input and output portion and output from the first coolant input and output portion.

### Technique B15

The heat exchange plate according to any one of the techniques B9 to B14, further including:
at least one first branch refrigerant flow path connecting the third refrigerant flow path and the first refrigerant flow path; and
at least one second branch refrigerant flow path connecting the third refrigerant flow path and the second refrigerant flow path.

### Technique B16

The heat exchange plate according to any one of the techniques B9 to B15, in which
a refrigerant circuit which includes at least a compressor and a condenser, in which the refrigerant flows, and which is provided on the vehicle body is connectable to the refrigerant input portion and the refrigerant output portion.

### Third Embodiment

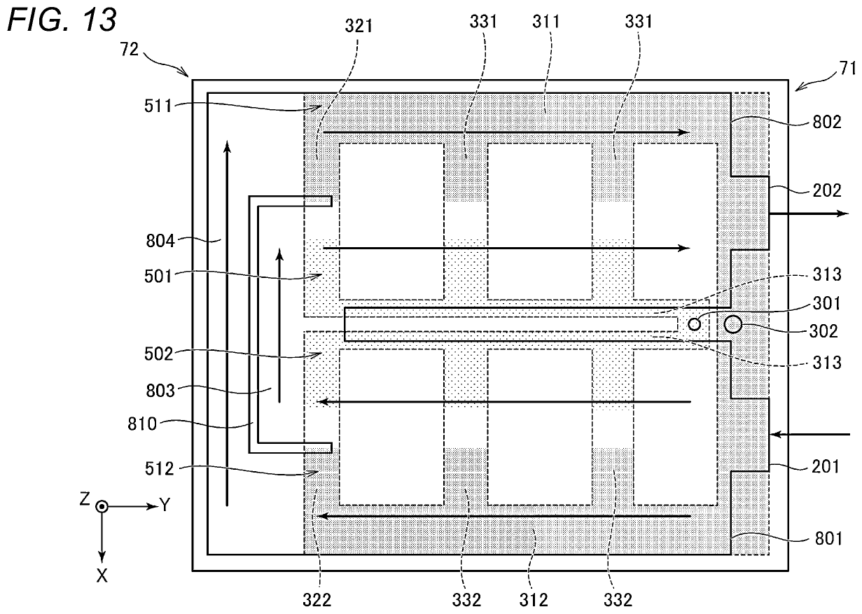

FIG. 13 is a plan view showing a configuration example of the heat exchange plate 100 according to a third embodiment.

A refrigerant layer 300 in the third embodiment may have the same configuration as the refrigerant layer 300 in the first embodiment. Accordingly, a description of the refrigerant layer 300 is omitted here.

The coolant layer 200 includes the first coolant input and output portion 201, the second coolant input and output portion 202, a first coolant flow path 801, a second coolant flow path 802, a third connection coolant flow path 803, and a fourth connection coolant flow path 804.

The first coolant input and output portion 201 is disposed at the first end portion 71, and the coolant is input to and output from the heat exchange plate 100.

The second coolant input and output portion 202 is disposed at the first end portion 71, and the coolant is input to and output from the heat exchange plate 100.

The first coolant flow path 801 is connected to the first coolant input and output portion 201, and is disposed between the first surface 101 and the second surface 102 along a predetermined direction (for example, a Y axis direction).

The second coolant flow path 802 is connected to the second coolant input and output portion 202, and is disposed between the first surface 101 and the second surface 102 along a predetermined direction (for example, the Y axis direction).

In plan view, the first coolant flow path 801 may overlap with at least a part of the second refrigerant flow path 312, at least a part of the second branch refrigerant flow paths 332, and at least a part of the third refrigerant flow path 313. Accordingly, the coolant flowing through the first coolant flow path 801 mainly performs heat exchange with the second low-temperature refrigerant 502 and the second high-temperature refrigerant 512 flowing through the refrigerant layer 300.

In plan view, the second coolant flow path 802 may overlap with at least a part of the first refrigerant flow path 311, at least a part of the first branch refrigerant flow paths 331, and at least a part of the third refrigerant flow path 313. Accordingly, the coolant flowing through the second coolant flow path 802 mainly performs heat exchange with the first low-temperature refrigerant 501 and the first high-temperature refrigerant 511 flowing through the refrigerant layer 300.

At the second end portion 72, the third connection coolant flow path 803 connects a part of the first coolant flow path 211 closer to the third refrigerant flow path 313 than the second refrigerant flow path 312 and a part of the second coolant flow path 802 closer to the third refrigerant flow path 313 than the first refrigerant flow path 311.

At the second end portion 72, the fourth connection coolant flow path 804 connects a part of the first coolant flow path 211 closer to the second refrigerant flow path 312 than the third refrigerant flow path 313 and a part of the second coolant flow path 802 closer to the first refrigerant flow path 311 than the third refrigerant flow path 313.

As illustrated in FIG. 13, the third connection coolant flow path 803 and the fourth connection coolant flow path 804 may be achieved by providing a partition wall 810 in the coolant layer 200.

According to this configuration, the coolant flows to every corner on the second end portion 72 side in the coolant layer 200. Accordingly, the coolant layer 200 can also appropriately cool the secondary battery 30 that is disposed near the corner on the second end portion 72 side.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely in a range without departing from the gist of the invention.

The present application is based on Japanese Patent Application No. 2022-106394 filed on Jun. 30, 2022, and the contents thereof are incorporated herein by reference. Further, the present application is based on a Japanese patent application (Japanese Patent Application No. 2022-106395) filed on Jun. 30, 2022, and the contents thereof are incorporated herein by reference. Further, this is a continuation of International Application No. PCT/JP2023/006917 filed on 5 Feb. 27, 2023 and the contents thereof are incorporated herein by reference.

### INDUSTRIAL APPLICABILITY

The technique of the present disclosure can be used in a heat exchange plate including a coolant and a refrigerant.

What is claimed is:

1. A vehicle comprising:
a vehicle body;
a first wheel and a second wheel coupled to the vehicle body;
a secondary battery disposed along a predetermined plane in the vehicle body;
a heat exchange plate disposed along the predetermined plane in the vehicle body; and
an electric motor that drives at least the first wheel using electric power supplied from the secondary battery, wherein
the vehicle is movable in a predetermined direction by the first wheel and the second wheel,
the heat exchange plate includes
a first surface disposed along the predetermined plane and being able to exchange heat with the secondary battery,
a second surface disposed along the predetermined plane and opposite to the first surface,
a first end portion in the predetermined direction,
a second end portion opposite to the first end portion in the predetermined direction,
a refrigerant input portion disposed at the first end portion and configured to allow a refrigerant to enter the heat exchange plate,
a refrigerant output portion disposed at the first end portion and configured to allow the refrigerant to exit the heat exchange plate,
a first refrigerant flow path connected to the refrigerant output portion and disposed along the predetermined direction between the first surface and the second surface,
a second refrigerant flow path connected to the refrigerant output portion and disposed along the predetermined direction between the first surface and the second surface,
a third refrigerant flow path connected to the refrigerant input portion and disposed along the predetermined direction between the first surface and the second surface and between the first refrigerant flow path and the second refrigerant flow path,
a first connection refrigerant flow path connecting the third refrigerant flow path and the first refrigerant flow path between the first surface and the second surface, and
a second connection refrigerant flow path connecting the third refrigerant flow path and the second refrigerant flow path between the first surface and the second surface,
the refrigerant that has entered the heat exchange plate from the refrigerant input portion is movable from the third refrigerant flow path through the first connection refrigerant flow path and the first refrigerant flow path to the refrigerant output portion, and the refrigerant that has entered the heat exchange plate from the refrigerant input portion is movable from the third refrigerant flow path through the second connection refrigerant flow path and the second refrigerant flow path to the refrigerant output portion,
the heat exchange plate further includes
a first coolant input and output portion disposed at the first end portion and configured to allow a coolant to be input to and output from the heat exchange plate,
a second coolant input and output portion disposed at the first end portion and configured to allow the coolant to be input to and output from the heat exchange plate,
a first coolant flow path connected to the first coolant input and output portion and disposed along the predetermined direction between the first surface and the second surface,
a second coolant flow path connected to the second coolant input and output portion and disposed along the predetermined direction between the first surface and the second surface,
a first connection coolant flow path connecting a part of the first coolant flow path closer to the second refrigerant flow path than the third refrigerant flow path and a part of the second coolant flow path closer to the third refrigerant flow path than the first refrigerant flow path at the second end portion, and
a second connection coolant flow path connecting a part of the first coolant flow path closer to the third refrigerant flow path than the second refrigerant flow path and a part of the second coolant flow path closer to the first refrigerant flow path than the third refrigerant flow path at the second end portion, and
the coolant that has entered the heat exchange plate from the first coolant input and output portion is movable from the first coolant flow path through the first connection coolant flow path and the second coolant flow path to the second coolant input and output portion, and the coolant that has entered the heat exchange plate from the first coolant input and output portion is movable from the first coolant flow path through the second connection coolant flow path and the second coolant flow path to the second coolant input and output portion.

2. The vehicle according to claim 1, wherein
the first coolant flow path includes, between the first surface and the second surface,
a first branch flow path disposed closer to the second refrigerant flow path than the third refrigerant flow path and connected to the first connection coolant flow path, and
a second branch flow path disposed closer to the third refrigerant flow path than the second refrigerant flow path and connected to the second connection coolant flow path, and
the second coolant flow path includes, between the first surface and the second surface,
a third branch flow path disposed closer to the third refrigerant flow path than the first refrigerant flow path and connected to the first connection coolant flow path, and
a fourth branch flow path disposed closer to the first refrigerant flow path than the third refrigerant flow path and connected to the second connection coolant flow path.

3. The vehicle according to claim 1, wherein
the heat exchange plate further includes
at least one first branch refrigerant flow path connecting the third refrigerant flow path and the first refrigerant flow path, and
at least one second branch refrigerant flow path connecting the third refrigerant flow path and the second refrigerant flow path.

4. The vehicle according to claim 1, wherein
between the first surface and the second surface, at least the first coolant flow path and the second coolant flow path are disposed closer to the first surface than the first refrigerant flow path, the second refrigerant flow path, and the third refrigerant flow path.

5. The vehicle according to claim 1, wherein
between the first surface and the second surface, at least the first refrigerant flow path, the second refrigerant flow path, and the third refrigerant flow path are disposed closer to the first surface than the first coolant flow path and the second coolant flow path.

6. The vehicle according to claim 1, wherein
each of the first connection coolant flow path and the second connection coolant flow path is formed by a hose.

7. The vehicle according to claim 6, wherein
the heat exchange plate includes a first heat exchange plate and a second heat exchange plate,
the first coolant flow path is formed in the first heat exchange plate, and
the second coolant flow path is formed in the second heat exchange plate.

8. The vehicle according to claim 1, wherein
the first connection coolant flow path and the second connection coolant flow path cross three-dimensionally.

9. The vehicle according to claim 1, further comprising:
a coolant circuit which is connected to the first coolant input and output portion and the second coolant input and output portion and in which the coolant circulates.

10. The vehicle according to claim 1, further comprising:
a refrigerant circuit which is connected to the refrigerant input portion and the refrigerant output portion, which includes at least a compressor and a condenser, and in which the refrigerant flows.

11. A heat exchange plate mountable on a vehicle movable in a predetermined direction by a first wheel and a second wheel,
the vehicle including
a vehicle body,
the first wheel and the second wheel coupled to the vehicle body,
a secondary battery disposed along a predetermined plane in the vehicle body, and
an electric motor configured to drive at least the first wheel using electric power supplied from the secondary battery,
the heat exchange plate comprising:
a first surface disposed along the predetermined plane and being able to exchange heat with the secondary battery;
a second surface disposed along the predetermined plane and opposite to the first surface;
a first end portion in the predetermined direction;
a second end portion opposite to the first end portion in the predetermined direction;
a refrigerant input portion disposed at the first end portion and configured to allow a refrigerant to enter the heat exchange plate;
a refrigerant output portion disposed at the first end portion and configured to allow the refrigerant to exit the heat exchange plate;
a first refrigerant flow path connected to the refrigerant output portion and disposed along the predetermined direction between the first surface and the second surface;
a second refrigerant flow path connected to the refrigerant output portion and disposed along the predetermined direction between the first surface and the second surface;
a third refrigerant flow path connected to the refrigerant input portion and disposed along the predetermined direction between the first surface and the second surface and between the first refrigerant flow path and the second refrigerant flow path;
a first connection refrigerant flow path connecting the third refrigerant flow path and the first refrigerant flow path between the first surface and the second surface; and
a second connection refrigerant flow path connecting the third refrigerant flow path and the second refrigerant flow path between the first surface and the second surface, wherein
the refrigerant that has entered the heat exchange plate from the refrigerant input portion is movable from the third refrigerant flow path through the first connection refrigerant flow path and the first refrigerant flow path to the refrigerant output portion, and the refrigerant that has entered the heat exchange plate from the refrigerant input portion is movable from the third refrigerant flow path through the second connection refrigerant flow path and the second refrigerant flow path to the refrigerant output portion,
the heat exchange plate further comprises:
a first coolant input and output portion disposed at the first end portion and configured to allow a coolant to be input to and output from the heat exchange plate;
a second coolant input and output portion disposed at the first end portion and configured to allow the coolant to be input to and output from the heat exchange plate;
a first coolant flow path connected to the first coolant input and output portion and disposed along the predetermined direction between the first surface and the second surface;
a second coolant flow path connected to the second coolant input and output portion and disposed along the predetermined direction between the first surface and the second surface;
a first connection coolant flow path connecting a part of the first coolant flow path closer to the second refrigerant flow path than the third refrigerant flow path and a part of the second coolant flow path closer to the third refrigerant flow path than the first refrigerant flow path at the second end portion; and
a second connection coolant flow path connecting a part of the first coolant flow path closer to the third refrigerant flow path than the second refrigerant flow path and a part of the second coolant flow path closer to the first refrigerant flow path than the third refrigerant flow path at the second end portion, and
the coolant that has entered the heat exchange plate from the first coolant input and output portion is movable from the first coolant flow path through the first connection coolant flow path and the second coolant flow path to the second coolant input and output portion, and the coolant that has entered the heat exchange plate from the first coolant input and output portion is movable from the first coolant flow path through the second connection coolant flow path and the second coolant flow path to the second coolant input and output portion.

12. The heat exchange plate according to claim 11, wherein
the first coolant flow path includes, between the first surface and the second surface,
a first branch flow path disposed closer to the second refrigerant flow path than the third refrigerant flow path and connected to the first connection coolant flow path, and
a second branch flow path disposed closer to the third refrigerant flow path than the second refrigerant flow path and connected to the second connection coolant flow path, and
the second coolant flow path includes, between the first surface and the second surface,
a third branch flow path disposed closer to the third refrigerant flow path than the first refrigerant flow path and connected to the first connection coolant flow path, and
a fourth branch flow path disposed closer to the first refrigerant flow path than the third refrigerant flow path and connected to the second connection coolant flow path.

13. The heat exchange plate according to claim 11, further comprising:
at least one first branch refrigerant flow path connecting the third refrigerant flow path and the first refrigerant flow path; and
at least one second branch refrigerant flow path connecting the third refrigerant flow path and the second refrigerant flow path.

14. The heat exchange plate according to claim 11, wherein
between the first surface and the second surface, at least the first coolant flow path and the second coolant flow path are disposed closer to the first surface than the first refrigerant flow path, the second refrigerant flow path, and the third refrigerant flow path.

15. The heat exchange plate according to claim 11, wherein
between the first surface and the second surface, at least the first refrigerant flow path, the second refrigerant flow path, and the third refrigerant flow path are disposed closer to the first surface than the first coolant flow path and the second coolant flow path.

16. The heat exchange plate according to claim 11, wherein
each of the first connection coolant flow path and the second connection coolant flow path is formed by a hose.

17. The heat exchange plate according to claim 16, wherein
the heat exchange plate includes a first heat exchange plate and a second heat exchange plate,
the first coolant flow path is formed in the first heat exchange plate, and
the second coolant flow path is formed in the second heat exchange plate.

18. The heat exchange plate according to claim 11, wherein
the first connection coolant flow path and the second connection coolant flow path cross three-dimensionally.

19. The heat exchange plate according to claim 11, wherein
a coolant circuit in which the coolant circulates and which is provided in the vehicle body is connectable to the first coolant input and output portion and the second coolant input and output portion.

20. The heat exchange plate according to claim 11, wherein
a refrigerant circuit which includes at least a compressor and a condenser, in which the refrigerant flows, and which is provided in the vehicle body is connectable to the refrigerant input portion and the refrigerant output portion.
